(19) United States
(12) Patent Application Publication
(10) Pub. No.: US 2014/0089231 A1
(43) Pub. Date: Mar. 27, 2014

(54) Portable Multifunction Telecommunication Scale

(71) Applicants: Roshan Jhunja, New York, NY (US); Sylvia Anne Stein, New York, NY (US)

(72) Inventors: Roshan Jhunja, New York, NY (US); Sylvia Anne Stein, New York, NY (US)

(21) Appl. No.: 13/626,856

(22) Filed: Sep. 25, 2012

(51) Int. Cl. G01G 23/42; G06Q 30/00

(52) U.S. Cl. 705/407; 177/2

(57) ABSTRACT

Multifunction portable computing devices capable of functioning as digital scales are described. For example, an object may be placed on the screen of a stationary smartphone, which in turn will calculate and display the weight of said object.

### CROSS-REFERENCE TO RELATED APPLICATIONS

U.S. Pat. No. 7,511,702, Issue Date Mar. 31, 2009—Force and location sensitive display

U.S. Pat. No. 4,960,177, Issue Date Oct. 2, 1990—Silicon membrane micro-scale

U.S. Pat. No. 4,594,639, Issue date: Jun. 10, 1986—Capacitive pressure detector

U.S. Pat. No. 6,662,663, Issue date: Dec. 16, 2003—Pressure sensor with two membranes forming a capacitor

U.S. Pat. No. 5,447,074, Issue date: Sep. 5, 1995—Strain gauge transducer force or weight measurement arrangement and touch tablet

U.S. Pat. No. 7,897,884, Issue date: Mar. 1, 2011—Method and system of a multi-zone capacitive force-measuring based load

U.S. Pat. No. 5,837,946, Issue date: Nov. 17, 1998—Force sensitive scale and dual load sensor cell for use therewith

U.S. Pat. No. 4,800,973, Issue date: Jan. 31, 1989—Portable electronic scale of minimal thickness and weight

U.S. Pat. No. 7,741,569, Issue date: Jun. 22, 2010—Electronic weight scale

U.S. Pat. No. 5,447,074, Issue date: Sep. 5, 1995—Strain gauge transducer force or weight measurement arrangement and touch tablet

Application Ser. No. 12/394,951: Filing date: Feb. 27, 2009—TOUCH-SENSITIVE DISPLAY INCLUDING A FORCE-SENSOR AND PORTABLE ELECTRONIC DEVICE INCLUDING SAME

### BRIEF DESCRIPTION OF THE SEVERAL VIEWS OF THE DRAWING

FIG. 1a is an oblique view of an example of a Portable Multifunction Telecommunication Scale (aka PMTS) with an object placed on the weighing surface of the PMTS. A more detailed explanation of the PMTS is provided in the following section. FIG. 1b is an oblique view of an example of a PMTS with an object placed on the screen of the PMTS, and the weighing surface displaying the weight of the object. FIG. 1c is an oblique view of an example of a PMTS with an object placed on the weighing surface of the PMTS, and the weighing surface displaying a zip code. FIG. 1d is an oblique view of an example of a PMTS with an object placed on the weighing surface of the PMTS, and the weighing surface displaying shipping costs and a way to purchase shipping for the object.

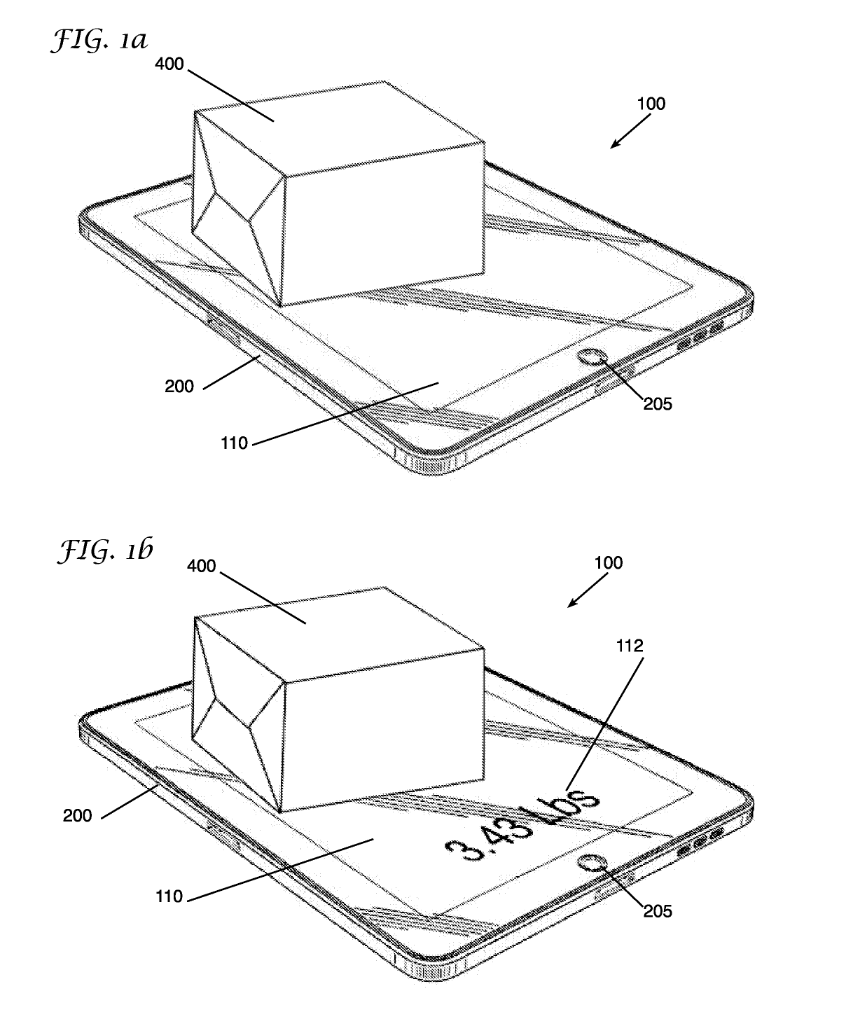

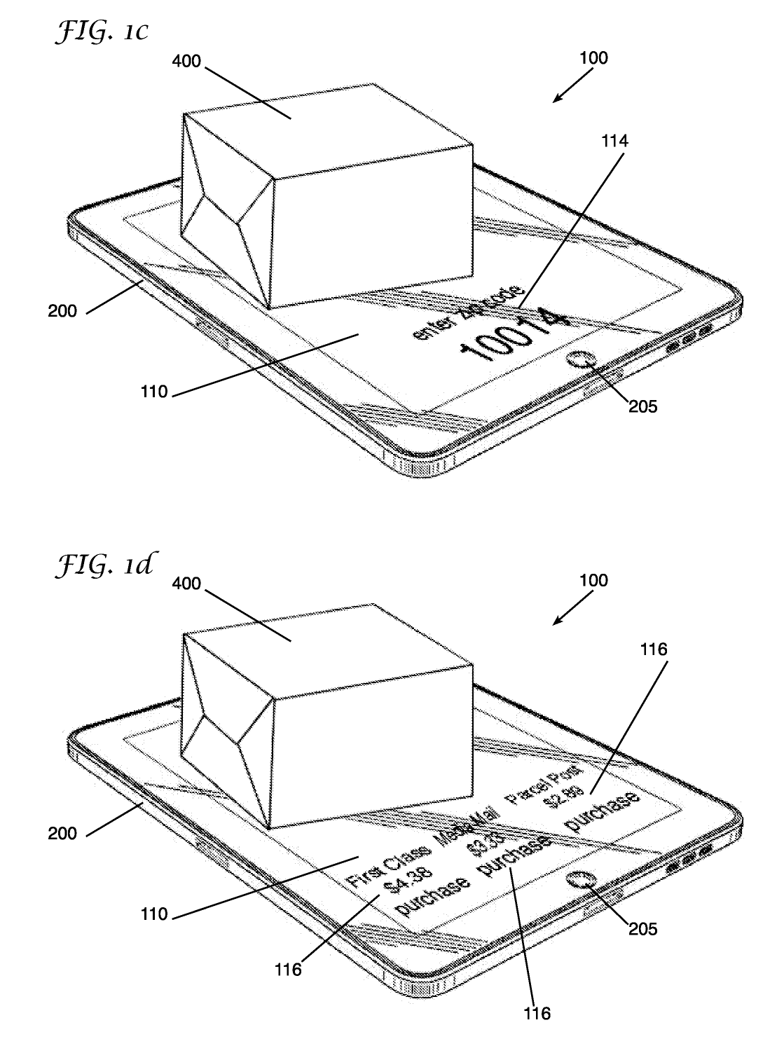

Reference is now made to FIGS. 1(a, b, c & d), which shows an oblique view of an example of a PMTS 100. The PMTS included housing 200 that houses the internal components and frames the weighing surface 110 such that the weighing surface 110 is exposed for user-interaction when the PMTS 100 is in use.

Referring again to FIGS. 1(a, b, c & d), the PMTS 100 may also include physical buttons. In the present example, the portable device 100 includes one on/off button 205 in the housing 200. Buttons for performing functions on the PMTS 100 may also be virtual features, rendered on the weighing surface 110.

Referring again to FIGS. 1(a, b, c & d), a plurality of force sensors 300 is enclosed in the PMTS. Referring to FIG. 1a, there is shown a solid object 400 resting on the weighing surface 110. The surface of the weighing surface 110 is in a horizontal position such that the object 400 rests in one position on the flat screen display 110. Referring to FIG. 1b, there is shown the weight 112 of the object 400 displayed on the weighing surface 110. Referring to FIG. 1c, there is shown the zip code 214 of the destination of the object 400 displayed on the weighing surface 110 for the purpose of calculating postage. Referring to FIG. 1d, there is shown the different postage rates, and a way to purchase postage 116 of the object 400 displayed on the weighing surface 110.

### DETAILED DESCRIPTION OF THE INVENTION

The following sections I-X provide a guide to interpreting the present application.

The following sections provide a guide to interpreting the present application.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

A reference to “descriptive element” or “descriptive characteristic” refers to information which can characterize, define or otherwise imply known details about an object, for example the “voice data” stored on the platform described by the present application.

The terms “including”, “comprising” and variations thereof mean “including but not limited to”, unless expressly specified otherwise.

The terms “a”, an and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of, when such phrase modifies a plurality of things does not mean “one of each of the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase the “data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

The terms “enhancement”, “high quality” and other like terms refer to a relative assessment of overall quality which is better than some average or comparison point. Similarly the term “low quality” refers to a relative assessment of overall quality lower than some average or comparison point. These qualitative assessments are not understood to be incontrovertible and may originate from a variety of sources including voting results, expert opinion and automated assessment using computer algorithms or sensors.

The term “re-purpose” and like terms indicate that something has been employed in a new usage, context or application which differs in some way from its original usage, context or application.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to does not mean that the term “including” means something other than “including but not limited to”.

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used. The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate). Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Weighing sensor or weight sensor shall refer to any one of a strain gauge, load cell, force sensor or other apparatus capable of measuring the quantity of force applied to it and converting this measurement into an electronic signal proportional to the force, possibly through incorporation of an analog-to-digital converter.

Weighing apparatus shall refer to a collection of one or more weight sensors, a load surface to which weight is applied and measured, and the placement and configuration of the above weight sensors and load surface. The weighing apparatus as defined shall represent a subsystem on which an object can be placed and one or more electronic signals generated in response to the force exerted upon the apparatus by the weight of the object.

Weighing Surface shall refer to an externally facing surface of an electronic device which is specified for placement of an object to be weighed. The Weighing Surface shall directly transmit the force exerted by the object to the weighing apparatus described above.

Weight value shall refer to the determination made by a processor as to the magnitude of weight applied to the weighing apparatus, such determination arising from the processor interpreting one or more electronic signals supplied to it by the weighing apparatus, in isolation or in conjunction with readings from other available sensors which may exist to enhance accuracy.

A Portable Multifunction Telecommunication Device aka PMTD, (also known as a mobile device, handheld computer or simply handheld) shall refer to a small, portable computing device, typically having a general-purpose computer processor, display screen and/or a miniature keyboard and weighing less than 2 pounds (0.91 kg), that has an operating system (OS) and that can run various types of application software, sometimes known as apps. Portable electronic devices are typically equipped with touch screen sensors, WI-FI, cellular data capabilities, Bluetooth and GPS in addition to other sensing apparatus like motion and light sensors, and image sensors for camera functions. Examples of portable electronic devices include smartphones, tablet computers and personal digital assistants.

A Portable Multifunction Telecommunication Scale aka PMTS shall refer to any portable multifunction telecommunication device which incorporates a weighing apparatus either directly into its packaging or by means of an accessory which is connected to the portable electronic device. While determining the weight value is not the primary purpose of the PMTS, the electronic signals originating from the weighing apparatus may be supplied to one or more processors present within the portable multifunction telecommunication device for ascertaining a weight value, and further, may be supplied to a range of applications hosted on the Portable Multifunction Telecommunications Device. Alternatively, these signals may be transmitted by the portable multifunction telecommunication device to other portable multifunction telecommunication device with processors for determination of a weight value.

Application can refer to any sequence of computer instructions designed to effect a particular outcome.

### IV. Disclosed Examples and Terminology are Not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim. The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases or repositories are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device, which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. §112, Paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of or the phrase “steps of in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### IX. Incorporation by Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference.

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution hi story of the present application, but not to the prosecution history of any other patent or patent application, regardless of whether there are other patent applications that are considered related to the present application, and regardless of whether there are other patent applications that share a claim of priority with the present application.

### XII. Disclosure

This disclosure describes a method for incorporating a weighing apparatus into the structure of a Portable Multifunction Telecommunications Device (PMTD) and connecting the output of the apparatus with the functionality of the PMTD or applications that run on the PMTD.

A number of weighing scales exist in the marketplace, including for example, professional scales designed for weighing vehicles or manufacturing materials, home or doctor's office models for weighing people or animals, counter-top scales useful for weighing and pricing provisions, office models designed for weighing envelopes and packages, kitchen scales useful for weighing recipe ingredients, milligram scales useful for weighing gems, and also useful in chemical and pharmaceutical laboratories where very minute measurements are required, among others. Mechanisms used to calculate the weight value of an object typically employ placing the object on a flat horizontal surface, which connects to a mechanical or electronic weight sensor. A digital weighing scale includes an interface to display the weight of the object. Most digital weighing scales are not designed with integrated wireless telecommunications, capable of relaying the weight data to another device or software application. Those that are, such as the Withings Wi-Fi Body Scale which is equipped with a wireless connection to send weight and body fat information directly to a Web page, portable communication device or Twitter account, are not designed to be portable or as multi-function devices but are instead purpose-specific.

Portable Multifunction Telecommunications Devices (PMTDs), such as smart phones, tablets and other portable communication devices generally include a variety of sensors, including accelerometers, digital compasses, gyroscopes, GPS', microphones, and cameras. Many PMTDs also include capacitance or resistance detection capabilities incorporated into the display, designed to capture touch or stylus inputs for the purpose of accessing functionality or entering data. Some PMTDs further incorporate force sensors into their displays, in a manner such as that disclosed in cross-referenced U.S. Pat. No. 7,511,702. There are sensors capable of measuring a sufficiently broad spectrum of applied forces so as to make them suitable for scale applications. A subset of these sensors have sufficiently minimal form factor and profile so as to make them suitable for embedding in the form factor of today's PMTDs. An example of such a sensor is the FlexiForce™ A201 force sensor.

The existing PMTD sensing capabilities mentioned above may be capable of registering differing levels of pressure to a degree sufficient for discerning input, but unlike the weighing apparatus described herein the prior art of force sensors in PMTDs are not designed for static load measurements of sufficient force range with reasonable accuracy to function reliably in weight scale applications. Instead these devices are designed to distinguish whether a specific threshold of force has been crossed in order to signal an input. Furthermore existing methods of incorporating force sensors into PMTDs are mainly coupled with touch detecting capabilities whereas the weighing apparatus described herein is designed to operate specifically in the absence of touch input, in a manner desirable for isolating the weight of an object.

This application describes incorporating a weighing apparatus, capable of determining a weight value in conjunction with a processor, as an integral part of a Portable Multifunction Telecommunications Device. The resulting device will be capable of measuring a static amount of pressure applied directly to itself when instructed to do so, recording, communicating or outputting measurement data on a display, and integrating the data with the functionality of the PMTD, or applications that run on the PMTD.

The weight sensors incorporated into the weighing apparatus described in this application are capable of calculating weights between various ranges, each to within 0.1% accuracy. A number of these sensors could be used in combination to improve the range or accuracy of the weighing capabilities of the portable scale. For example, four sensors of differing range capabilities such as 0-1 lb, 0-10 lb, 0-25 lb, 0-50 lb could be simultaneously connected within the weighing apparatus to the weighing surface. After the weighing function is invoked by the software of the Portable Multifunction Telecommunications Scale, a rough measure of weight is first gathered by the sensor of the greatest range. Since this sensor at the lower end of its weight range has less accuracy than the other sensors present, the sensor having the maximum range nearest but greater than the rough measure of weight is selected to provide a secondary, more accurate measurement of weight.

As an example when the Portable Multifunction Telecommunications Scale is laid flat, or almost flat, on a surface, an object stably and completely resting on the display screen of the device can be measured, its weight can be displayed using metric, imperial or any other unit of weight or force measurement. The weighing apparatus incorporated into the device provides a weight value, which can be shared with any number of applications and algorithms available to the PMTS and serving a range of functions. For example, the weight of a recipe ingredient placed on the phone, tablet or other communication device could be measured and that information used to recalculate the amounts and proportions required to make the recipe.

The weight values could be shared via an API—or application programming interface. This API would provide a set of functions which would permit an application to interrogate the processor or operating system of the device which housed the weighing apparatus, to retrieve the current static load being applied or any historical record of static load amounts applied in the past. Applications may include any running directly on the device, or others running on networked computers or devices, which were granted access via the API to the weight values.

In one embodiment the Portable Multifunction Telecommunications Scale would be useful in a commercial setting, where a purchaser of a commodity might be interested in an objective weight measurement prior to purchase, in order to be assured they are getting as much of the product being purchased as the seller represents. The weight value could further be supplemented by employing other sensors and technologies available on the device, such as bar code scanning and database look-ups to identify the product being considered. Once the product was identified it could be compared with other sellers' pricing of identical weight amounts.

Weight determinations made by the Portable Multifunction Telecommunications Scale could act in concert with other sensors to enable advanced functions or improved quality in existing functions. In one embodiment a weight value obtained from the portable scale could combine with imaging from an onboard image sensor and image processing capabilities to more accurately identify an item unknown to the user of the device. Such identification would benefit from the additional sensor data available to match against a networked database of known items' shapes, sizes and weight.

In one embodiment, the Portable Multifunction Telecommunications Scale would be useful to measure the weight of a baby, child or adult, in order for individuals or health-care workers to track growth or manage health. The computation abilities available in addition to the weight sensor would enable a variety of useful functions including storing measurements over time, analyzing weight relative to manual inputs such as calories consumed or other sensor inputs such as physical activity recorded. Data networking capabilities of modern smart phones and tablets, either of which could serve as the basis for a portable scale could also enable the instant transmission of weight measurements to remote locations for purposes of medical monitoring, social networking diet progress updates, marketing or other research purposes.

In one embodiment, a Portable Multifunction Telecommunications Scale would be useful in measuring luggage to be assured that it is under the weight limit or to calculate fees assessed by airlines for luggage over established weight allowances. Although similar purpose-built devices exist today, it would be convenient to take advantage of this capability if available in a device that would have been carried all the time, such as a portable scale implementation in a smart phone or tablet computer.

In another embodiment, the Portable Multifunction Telecommunications Scale would be useful to measure the weight of a letter or package for purposes of determining appropriate postage. When combined with software provided by shipping carriers or the US post office, a portable scale implemented in a smart phone or tablet could permit a user to address, calculate and purchase appropriate postage from a single device.

In one embodiment, the Portable Multifunction Telecommunications Scale could be useful in an educational setting for teaching math concepts, or for measuring components of a science experiment to make sure that the correct amount of compounds are used in an experiment.

In one embodiment the Portable Multifunction Telecommunications Scale could be useful in a home or professional kitchen to adjust recipes based upon the availability, or volume, of a single ingredient. The weight data of one item could interface with an application that recalculates the measurements of the other ingredients in the recipe to obtain a desirable ratio. Again, the convenience of having this capability in a multipurpose device likely to be on hand at all times compares favorably against needing a purpose-specific device.

In one embodiment, the Portable Multifunction Telecommunications Scale would be useful in measuring the force of an object against it, for example in a physical rehabilitation setting to measure the strength of a joint after an injury or for insuring that the proper force is applied for most effective therapy. In this embodiment the portability of the device makes it an attractive option relative to special-purpose and limited availability rehabilitation equipment.

This disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system for measuring weight comprising:
an electronic weighing apparatus embedded as an integral part of
a Portable Multifunction Telecommunications Device equipped with a display screen and wireless data networking capabilities,
wherein the electronic weighing apparatus registers the amount of static load exerted by gravity on an object placed on the weighing surface of the Portable Multifunction Telecommunications Device within an accuracy of 0.1% of the static load.

2. The system for measuring weight of claim 1 in which the weighing surface, which transmits the static load to the weighing apparatus is the screen of the Portable Multifunction Telecommunications Device

3. The system for measuring weight of claim 1 wherein the load registered by the weighing apparatus is relayed to a processor embedded in the Portable Multifunction Telecommunications Device which calculates a weight value.

4. The system for measuring weight of claim 3 wherein the weight value is displayed on the screen of the Portable Multifunction Telecommunications Device.

5. The system of claim 3 wherein the weight measurement is made available by the processor to other applications running on the Portable Multifunction Telecommunications Device by means of an application programming interface.

6. The system of claim 3 wherein the weight measurement is supplemented with image sensor data provided by the same Portable Multifunction Telecommunications Device, to enable object identification with enhanced accuracy.

7. The system of claim 3 wherein weight and other measurements recorded by the Portable Multifunction Telecommunications Device are compared with a database of recorded measurements in order to match against known objects having similar appearance and weight.

8. The system of claim 3 wherein a person can stand on the Portable Multifunction Telecommunications Device to measure their own body weight.

9. The system of claim 3 further comprising a recording system enabling a tracking and comparison of weight measurements over time.

10. The system of claim 5 wherein the weight measurement is provided to one or more applications running on the Portable Multifunction Telecommunications Device, or provided remotely to or more applications running on a device that is networked with the handheld computing device.

11. The system of claim 3 wherein the weight value is incorporated into shipping software for purposes of calculating shipping fees.

12. The system of claim 11 wherein the calculated shipping fee is associated with a printed label, bar code, QR code or other computer-readable code, and the fee deducted from a financial account.
